(19) United States
(12) Patent Application Publication
(10) Pub. No.: US 2005/0086024 A1
(43) Pub. Date: Apr. 21, 2005

(54) Semiconductor wafer location sensing via non contact methods

(75) Inventors: Edward D. Seeberger JR., Portland, OR (US); DelRae H. Gardner, Tualatin, OR (US); Felix J. Schuda, Saratoga, CA (US); Craig C. Ramsey, West Linn, OR (US)

Correspondence Address: Christopher R. Christenson;Westman, Champlin & Kelly, 900 Second Avenue South, Suite 1600, Minneapolis, MN, 55402-3319, US

(73) Assignee: CyberOptics Semiconductor Inc., Portland, OR (US)

(21) Appl. No.: 10/941,646

(22) Filed: Sep. 15, 2004

Related U.S. Application Data
(60) Provisional application No. 60/504,074, filed on Sep. 19, 2003.

(51) Int. Cl. G06F 15/00

(52) U.S. Cl. 702/150

(57) ABSTRACT

Embodiments of the present invention generally provide accurate spatial determination, in three dimensions, of the wafer location, along with the provision of information about the presence of any error conditions relative to the wafer(s) such as cross slotting or double stacked wafers inside the wafer carrier. A device in accordance with an embodiment of the invention can be used in conjunction with a wafer handling system which requires the measurement of a wafer's location before it can be picked up and passed through a set of processing steps.

### CROSS REFERENCE TO RELATED APPLICATIONS

This application claims priority of an earlier filed co-pending provisional application Ser. No. 60/504,074, filed Sep. 19, 2003, entitled SEMICONDUCTOR WAFER LOCATION SENSING VIA NON CONTACT METHODS.

### BACKGROUND OF THE INVENTION

The present invention relates to semiconductor wafer location sensing. More particularly, the present invention relates to location sensing of wafers and wafer-like objects via non contact methods.

Manufacturing semiconductor devices requires the precise locating and handling of semiconductor process wafers. A number of similarly-shaped objects (wafer-like objects) are also manufactured using semiconductor manufacturing techniques. Examples of wafer-like objects include, without limitation, reticles, LCD panels, film frames et cetera. With the increased use of edge gripping end effectors as the preferred handling method, it is necessary to precisely locate the position of a prospective wafer or wafer-like object in three-dimensional space before the end effector actually makes contact with the wafer or object.

A typical arrangement is depicted in FIG. 1. FIG. 1 illustrates a Front Opening Unified Pod (FOUP) 8 housing a number of wafers or wafer-like objects 12 in a known manner. Throughout the remainder of this description wafer and wafer-like object will be used interchangeably. It should be understood that embodiments of the present invention are practicable with wafers as well as wafer-like objects.

An edge gripping end effector 10 picks up a wafer 12 by first moving underneath the wafer 12. The effector grippers 14 must be located very close to the edge 16 of the wafer 12 before the one or more moveable edge grippers 14 on the effector 10 can extend and capture the wafer edge 16. A step is often required before the pick up sequence during which the precise location of the wafer edge 16 is determined. This step can be relatively time consuming due to the requirement to know the exact location of the wafer's center point. Incorrect location information can lead to improper pick-up which in turn can lead to wafer and tool damage. In order to determine the wafer location, one or more points along the wafer edge are generally located so that the center point can be calculated. When a through-beam sensor is used to locate the wafer edge, the measurement can be time consuming because the sensor must be iteratively advanced towards the wafer edge until the beam breaks indicating the wafer edge. The use of such a method is not only slow but requires edge sensors to be brought extremely close to the wafer edge 16 before the measurement of the location has been made. Embodiments of the present invention, described below, generally improve on this measurement technique by offering an alternative method which cuts a significant amount of time from the process while at the same time offering benefits in accuracy, safety and system reliability.

### SUMMARY OF THE INVENTION

One object of embodiments of the present invention is the accurate spatial determination, in three dimensions, of the wafer location, along with the provision of information about the presence of any error conditions relative to the wafer(s) such as cross slotting or double stacked wafers inside the wafer carrier. A device in accordance with an embodiment of the invention can be used in conjunction with a wafer handling system which requires the measurement of a wafer's location before it can be picked up and passed through a set of processing steps.

### BRIEF DESCRIPTION OF THE DRAWINGS

FIG. 1 is a diagrammatic view of a wafer handling system with which embodiments of the present invention are particularly useful.

FIG. 2 is a top plan view of wafer position determination using multiple range measurements in accordance with an embodiment of the present invention.

FIG. 3 is a diagrammatic view of a two-point wafer position calculation in accordance with embodiments of the present invention.

FIG. 4 is a diagrammatic view illustrating the use of triangulation in accordance with embodiments of the present invention.

FIG. 5 is a diagrammatic view of a range mapping sensor using a single illumination source in accordance with an embodiment of the present invention.

FIG. 6 is a diagrammatic view of a range mapping sensor with multiple sources in accordance with embodiments of the present invention.

FIG. 7 is a diagrammatic view of a system for calculating wafer position in accordance with embodiments of the present invention.

### DETAILED DESCRIPTION OF THE PREFERRED EMBODIMENTS

Typically a wafer handling system is calibrated before the tool goes online. Most stations in a process tool are very accurately calibrated in position, often to better than 100 um in all dimensions. The location of a process wafer inside of a wafer carrier such as a FOUP or cassette is not as well known because the wafer has room to move within the carrier by a few millimeters or more. This amount of uncertainty in position is too large for many edge gripping end effectors which require the wafer location to be known within better than 0.5 mm. In order to pick up a wafer correctly, the location of the wafer should be known in all three dimensions. However, due to mechanical constraints given in the wafer carrier environment, the measurement of the vertical location of the wafer is made via a method separate from the other two dimensions.

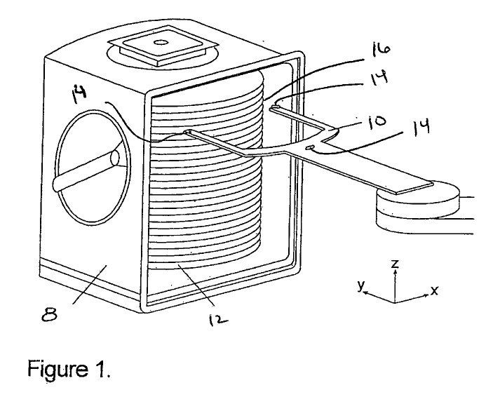

The vertical direction (z dimension in FIG. 1) must also be known accurately. This allows the end effector to be moved safely under the wafer while getting close enough to the bottom of the wafer to allow the edge gripper mechanisms to correctly make contact with the wafer edge. Of the three dimensions the z axis is the best controlled in a wafer carrier. However, there are still compelling reasons to verify the location of the wafer in this dimension. The existence of ultra thin wafers, wafers which are thinner than 300 um, leads to a situation where the middle of a wafer can droop down to a lower position than the nominal slot position. Detecting this condition can allow for real time compensation of the wafer handling system in which the sagging wafer is still picked up correctly. One method of determining the vertical position is through a wafer mapping scan. Wafer mapping is a well established technique used to determine presence or absence of a wafer in association with a particular slot in a wafer carrier. Wafer mapping is also used to verify that a wafer is properly placed in the slot without any error condition such as a cross-slot or double stack. If the wafer mapping sensor is precise enough in its determination, it can be used in conjunction with the wafer handling robot to give an accurate measure of vertical location.

One method of measurement in accordance with an embodiment of the invention makes use of a sensor with a narrow probe beam, which leads to accurate measurements of the wafer vertical position. Another embodiment employs an array of detectors, such as a CCD camera, to give the needed accuracy. An example of such a device is described later. The vertical extent of the detector array can be used to give a relative measure of wafer vertical location and also provide information about target thickness and tilt.

The x and y dimensions of a wafer in a wafer carrier are less well controlled than the z position. As a wafer sits in a FOUP, for example, the wafer easily can get moved outward (y-axis in FIG. 1) from its nominal position by 5 mm-10 mm or more. The wafer may also move either way in the horizontal direction (x axis). The uncertainty in wafer position relative to the x-y plane can lead to incorrect pick up, especially if an edge gripping end effector is employed. Typically an edge gripper requires the wafer to be within a window of 0.5 mm or better in order to insure proper contact. Even if the end effector has a larger capture range, such as 2.0 to 3.0 mm, if the wafer is off by more than 0.5 mm, the edge gripping mechanisms must push the wafer into position. This can lead to unwanted particle generation.

Gross wafer position error may be detected using separate position sensors. An example would be a break-the-beam sensor placed just outside the wafer carrier to detect any wafer that is protruding past the carrier edge. Using such a technique, every location where an error could occur requires a separate sensor either built into the carrier or onto the end effector itself. This leads to an increase in cost of the system. Even with separate sensors in place, only a wafer which is over 10 mm out of position would trigger a typical protrusion sensor leaving a significant positional range where the wafer is detected as valid but still not in position for a good effector pick-up.

A method for accurately determining the wafer position in the x-y plane is required. If the wafer's location in this plane is known to better than 0.1 mm, an edge gripping end effector can then be moved to the known position for proper pick-up. In accordance with one embodiment of the present invention, multiple points along the wafer's edge are measured with one or more range sensors in order to calculate the needed wafer position.

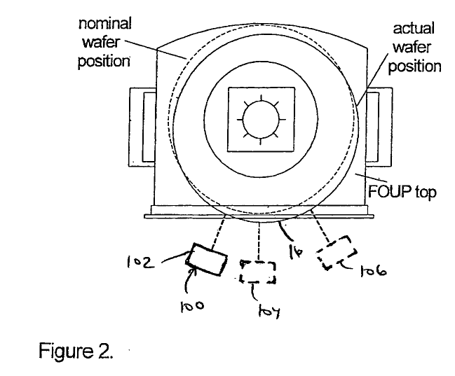

FIG. 2 is a top plan view illustrating a method of determining wafer position in accordance with an embodiment of the present invention. Using a range sensor 100, of any suitable type, at one or more known positions 102, 104, 106, a distance measurement is made at one or more points along the wafer's edge 16. Because sensor location is known, edge locations can be determined from the measured distances. With the knowledge of the edge locations in the tool's coordinate system, along with knowledge of the radius of the wafer 12, the center point of the wafer can be calculated. Knowledge of the location of a single point allows the Y location of the wafer center to be estimated. Knowledge of the locations of two points allows both the X and Y locations to be estimated.

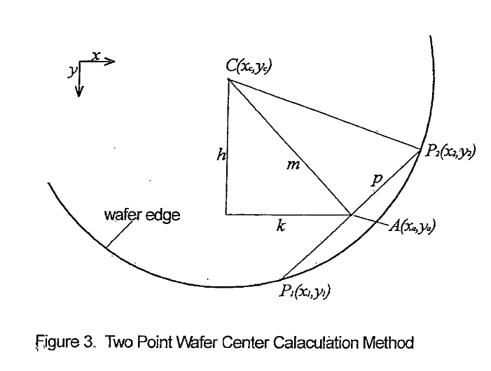

To illustrate a method of calculation—knowing the position of two points on the wafer edge consider the geometry of FIG. 3. Define the following known values:
P₁(x₁,y₁); P₂(x₂,y₂): Measured x and y positions on edge of wafer; and
R: Radius of target wafer.
Define A(xₐ,yₐ) as the midpoint between points P₁ and P₂ and m as the distance between A and the wafer center point C(XC,y_{c}). From the geometry of a right angle triangle the distance from point A to P₂ is:

$$p = \frac{1}{2} \sqrt{{( {x}_{2} - {x}_{1} )}^{2} + {( {y}_{2} - {y}_{1} )}^{2}}$$

By similar argument the distance m from point A to C is found:

$$m = \sqrt{{R}^{2} - {p}^{2}} = \frac{1}{2} \sqrt{4 {R}^{2} - {( {x}_{2} - {x}_{1} )}^{2} - {( {y}_{2} - {y}_{1} )}^{2}}$$

Finding the slope s of the line between P₁ and P₂ along with the relationship to line between A and C leads to the following two equations:

$$s = \frac{- k}{h} = \frac{( {y}_{2} - {y}_{1} )}{( {x}_{2} - {x}_{1} )}$$

From this and geometry the values for the x and y components of the line AC are found:

$$h = \frac{m}{\sqrt{( {s}^{2} + 1 )}} and k = \frac{m}{\sqrt{( 1 + \frac{1}{{s}^{2}} )}}$$

Finally the x and y components of the wafer center position can be calculated from substitution of the above relationships:

$${x}_{c} = ( {x}_{a} - k ) = \frac{{x}_{2} + {x}_{1}}{2} - \frac{\sqrt{4 {R}^{2} - {( {x}_{2} - {x}_{1} )}^{2} - {( {y}_{2} - {y}_{1} )}^{2}}}{2 \sqrt{{( \frac{( {x}_{2} - {x}_{1} )}{( {y}_{2} - {y}_{1} )} )}^{2} + 1}}$$

$${y}_{c} = ( {y}_{a} - h ) = \frac{{y}_{2} + {y}_{1}}{2} - \frac{\sqrt{4 {R}^{2} - {( {x}_{2} - {x}_{1} )}^{2} - {( {y}_{2} - {y}_{1} )}^{2}}}{2 \sqrt{{( \frac{( {y}_{2} - {y}_{1} )}{( {x}_{2} - {x}_{1} )} )}^{2} + 1}}$$

In a similar fashion more than two points can be used in the calculation of the wafer center point. The use of three or more points allows the radius of the wafer itself to remain unknown. With a larger number of edge location data points a curve fitting method can also be employed. An example would be a least squares best fit of a circle to the given points as an alterative to the direct calculation described above. Three or more points also allow for a more robust estimate of the wafer center because at least two of the three points will not be affected by the wafer orientation notch. Using more points also improves the calculation's accuracy by averaging out measurement errors.

Without departing from the spirit and scope of the invention, variations on the techniques described above can be provided. The measurement can be made statically by positioning a sensor in line with the approximate location of the wafer and measuring a range distance using any of a number of non-contact distance methods. Triangulation using a reflected emitter source is one exemplary method which will be described in greater detail below. Another technique involves the use of active confocal measurement. The confocal measurement principle makes use of actively scanning though the sensor focus range in order to determine the range to the reflected target. Focus-based range measurements can be accomplished by varying the focal length within the sensor itself as well as by physically moving the sensor along the optical axis. The edge locations can also be determined via modulation techniques where the distance to a target is measured by detecting the phase relationship of a modulated signal compared to the detected reflection. When modulation is used, multiple wavelengths provide an important benefit. Specifically, a target can be illuminated with more than one wavelength of light. The reflected signal will then contain interferences or beating patterns which change with the distance of the object. Interference can also be used for two coherent light sources of the same wavelength much like the operation of a standard interferometer.

To speed the process, the range measurement can also be made during a scan of the entire wafer carrier. Wafer scans are currently performed where a sensor is scanned past the wafer edges to detect the wafers as well as errors. In this active scenario, the edge location measurements are made while the sensor is in motion and the results are saved so that the location of each detected wafer can be calculated. The measurement of location of multiple points along the wafer's edge can be achieved via multiple wafer scans, or a single sensor can be configured to make the needed measurements in a single scan.

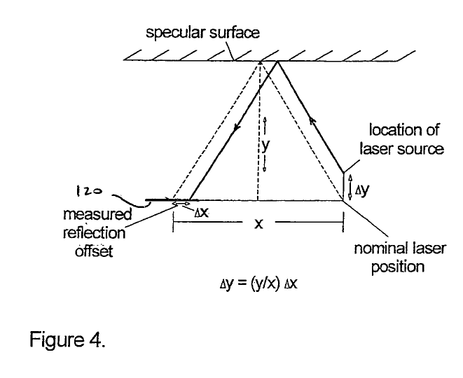

FIG. 4 illustrates triangulation, which is a well-established method for determination of a relative location in space. The position of a point is determined by reference to two or more other points whose position is known. In one variation, distances from known points to the point in question are measured and from these measurements the position of the point can be calculated. In another variation directions are measured allowing calculation of positions where the direction vectors intersect. Laser triangulation is a well established variation of the triangulation method. A laser source or LEDs project illumination onto an object at a known angle from the sensor device, and the point being measured is imaged from a second known angle onto a set of detectors, such as CCD detector array 120. Detector 120 can be any suitable device including any type of camera or linear array. Further, detector 120 can be comprised of one or more photo detectors or position sensitive detectors (PSD). Because the geometric relationship between the detector 120 and the illumination source is well known, a measurement of the relative distance can be made. As the target surface distance moves with respect to the sensor, the location of the imaged source light moves on the detector array. The measurement of this offset on the array leads directly to a measure of the distance to the target surface.

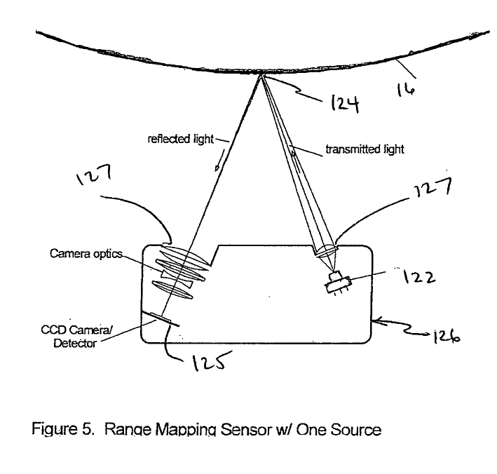

FIG. 5 illustrates a method and apparatus where a single light source 122 is used to determine the distance to one point 124 on the curved wafer edge 16. Although FIG. 5 illustrates source 122 and detector 125 within the same housing, they need not be in the same package. Optics 127 can be in front of either or both source 122 and detector 125. Optics 127 can include ambient filters, cylinder lenses to produce a stripe of light, laser collimating optics, CCD camera lenses, et cetera. The nominal working distances of optics 127 can range from within millimeters of the wafer to hundreds of millimeters. Device 126 is moved to multiple known positions, thus measuring the distance to multiple locations along the edge 16 in order to calculate the wafer position in both x and y. Alternatively, device 126 could incorporate multiple light sources to achieve the same result as moving to multiple positions.

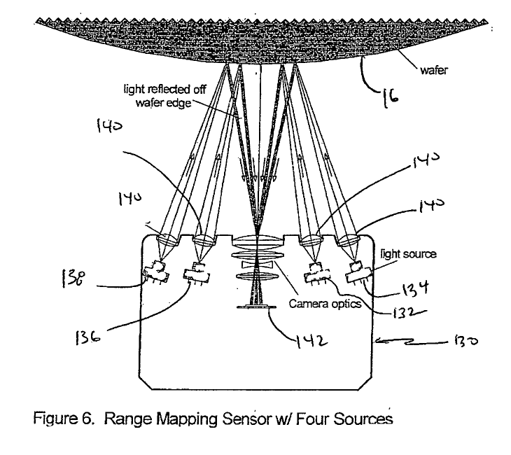

FIG. 6 illustrates a multiple source sensor embodiment in accordance with the present invention. The sensor 130 contains multiple laser sources 132, 134, 136, 138 each with suitable optics 140 and a known relative spatial relationship to the detector array. As sensor 130 is moved within the measurement window of wafer edge 16, laser sources 132, 134, 136, 138 are detected and measured for their location on detector array 142. With the spatial relationship of each reflection and with the knowledge of the wafer radius, the location of the wafer center is calculated in the x-y plane. The measurement can be done statically with the sensor placed in front of the wafer, or during a wafer mapping scan during which the same sensor can be used to determine the z axis position of the wafer.

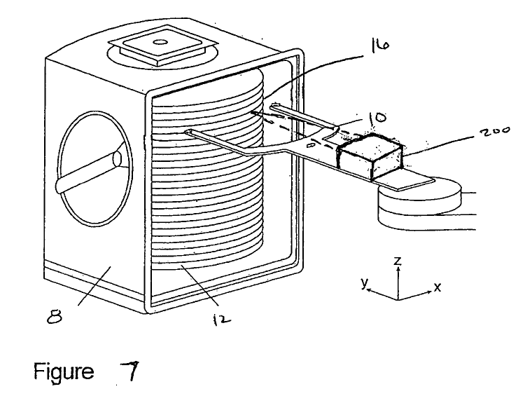

FIG. 7 is a diagrammatic view of a range sensor mounted above an end effector in accordance with an embodiment of the present invention. Sensor 200 can be any of the sensors described above or any suitable sensor that can provide a range measurement. Sensor 200 can scan wafers 12 within FOUP 8 by passing sensor 200 in the z direction while viewing the wafers. As described above, sensor 200 acquires range information relative to each wafer. Since the position of sensor 200 is known, wafer position information is computed based upon the measured range. As set forth above, it is preferred that at least two range measurements be made at varying positions in the X-Y plane. These multiple positions can be generated by multiple sources within sensor 200, or by using a single source, and physically moving sensor 200. In one embodiment, sensor 200 is scanned past wafers 12 while fixing the position of sensor 200 in the X-Y plane. Then, sensor 200 is moved in the X-Y plane a known amount, and the z-direction scan is repeated.

Semiconductor wafers are known for their large range of reflectivity and edge shape. A just-processed copper coating can approach 100% reflectivity while a dark nitride film coating can have a reflectivity of less than 0.1%. The consequence of this large range is the need for a wafer sensor that supports a very large dynamic range. This can be accomplished via a number of techniques used in conjunction with each other. The light source's output level can be dynamically controlled to automatically adjust to the light level appropriate for the target. The detector electronics also can give a degree of dynamic range control by the adjustment of associated gain and integration time values. Other helpful techniques involve increasing the signal to noise ratio of the system. A light filter can be used to filter out unwanted ambient light noise. The geometry of the detectors and sources can be chosen to give maximum reduction of stray reflections. Also the sources and detectors can be synchronized to give better detection performance.

There are a number of advantages provided by embodiments of the present invention. One advantage is measurement speed. When compared to the break-the-beam methods, embodiments of the present invention require a significantly smaller amount of time. Other methods require iteratively closing in on the position before finding the required location. Embodiments of the present invention do this measurement with no iteration. If the device is coupled with wafer carrier mapping and contains multiple sources the entire position measurement can be done in a single scan.

Another advantage is cost. In many cases a single range locating sensor can be used to replace multiple sensors and even in some cases entire operating steps. A process tool using a range sensor to calibrate effector pick-up could use the accuracy in the wafer location to avoid a pre-alignment step. A pre-aligner is a separate device in the tool where a wafer is typically placed for accurate locating before it is passed on to other process modules in the tool. This step is needed due to uncompensated pick-up error in the handling system. By offering a way to measure this handling error a range sensor can be used to achieve the same result as a pre-aligner, thus leading to the cost reducing step of removing the need for a pre-alignment process step.

Yet another advantage is the provision of an alternative method to break-the-beam end effectors. Some customers are blocked from implementing a wafer position solution due to the intellectual property rights listed in the previous section. Embodiments of the present invention offer an alternative solution to the problem.

Although the present invention has been described with reference to preferred embodiments, workers skilled in the art will recognize that changes may be made in form and detail without departing from the spirit and scope of the invention. For example, while ranging measurements have been described using electromagnetic radiation, sound can also be used. Thus, a modulated sound could be generated towards the object and a detector would be used to measure sound reflections coming off the object to indicate its presence, and possibly the range between the sensor and object.

1. A detection system comprising:
an assembly movable with respect to a wafer-like object carrier; and
a sensor disposed on the assembly and adapted to provide an indication of at least two-dimensional positional information relative to at least one wafer-like object in the carrier based upon energy reflected from the edge of the wafer-like object.

2. The system of claim 1, wherein the sensor includes a wafer-like object range sensor.

3. The system of claim 2, wherein the range sensor includes one source.

4. The system of claim 2, wherein the range sensor includes a plurality of sources.

5. The system of claim 4, wherein the range sensor includes four sources.

6. The system of claim 1, wherein the at least two-dimensional positional information is with respect to the z axis and the x axis.

7. The system of claim 1, wherein the at least two-dimensional positional information is with respect to the z axis and the y axis.

8. The system of claim 1, wherein the at least two dimensional positional information is with respect to the z axis and both the x and y axes.

9. The system of claim 1, wherein the sensor includes a Charge Coupled Device (CCD) detector.

10. The system of claim 1, wherein the sensor includes a CMOS sensor.

11. The system of claim 1, wherein the sensor includes a PSD.

12. The system of claim 9, wherein the detector facilitates extended dynamic range with adjustable gain.

13. The system of claim 9, wherein the detector facilitates extended dynamic range with changeable integration times.

14. The system of claim 1, and further comprising a light source with dynamic intensity control for extended dynamic range.

15. The system of claim 9, wherein the sensor includes a plurality of CCD detectors.

16. The system of claim 1, wherein the wafer-like object is a wafer.

17. The system of claim 1, and further comprising a source of emitted energy disposed to direct the energy upon the wafer-like object, and wherein reflected energy from the wafer-like object is detected by the sensor.

18. The system of claim 17, wherein the source of emitted energy is external to the sensor.

19. The system of claim 17, and further comprising at least one additional source of emitted energy.

20. A method calculating a position of a wafer-like object, the method comprising:
obtaining a plurality of range measurements from a plurality of edge positions on a wafer-like object; and
calculating overall wafer-like object position based on the plurality of range measurements.

21. The method of claim 20, wherein the location measurements are obtained in a single scan.

22. The method of claim 20, wherein the location measurements are obtained in a plurality of scans.

23. A method of determining a position of a round wafer-like object in a carrier, the method comprising:
measuring a range from a first known position to a first edge position on the wafer-like object;
measuring a range from a second known position to a second edge position on the wafer-like object; and
computing a center position of the round wafer-like object in at least two-dimensions.

24. The method of claim 23, wherein the first known position and the second known position are spaced from each other.

25. The method of claim 23, wherein each step of measuring a range is performed using a range sensor.

26. The method of claim 25, wherein the range sensor is movable relative to the round wafer-like object.

27. The method of claim 26, wherein the range sensor is attached proximate an end effector.

28. A sensor for use in detection of position of wafer-like objects, the sensor comprising:
a source disposed to project energy upon a wafer-like object;
a detector disposed to detect energy reflected from the wafer-like object; and
computing circuitry coupled to the detector and adapted to provide an indication of wafer presence and relative distance from the sensor to the wafer-like object.

29. The sensor of claim 28, wherein the detector includes a CCD detector.

30. The sensor of claim 28, wherein the detector includes a CMOS sensor.

31. The sensor of claim 28, wherein the detector includes a plurality of CCDs.

32. The sensor of claim 28, wherein the detector includes a plurality of CMOS sensors.

33. The sensor of claim 28, wherein the detector includes a PSD.

34. The sensor of claim 28, wherein the source includes a plurality of emitters.

35. The sensor of claim 34, wherein the source includes four emitters.
